(19) United States
(12) Patent Application Publication
(10) Pub. No.: US 2004/0073605 A1
(43) Pub. Date: Apr. 15, 2004

(54) Multi-tier web publishing software and system

(76) Inventor: Ralph F. Conley, JR., Miamisburg, OH (US)

Correspondence Address: Steven J. Rosen, Patent Attorney, 4729 Cornell Rd., Cincinnati, OH, 45241, US

(21) Appl. No.: 10/271,052

(22) Filed: Oct. 15, 2002

(51) Int. Cl. G06F 15/16

(52) U.S. Cl. 709/203

(57) ABSTRACT

Multi-tier publishing software includes URL's and publisher's content of tiered publishers that is at least partially controlled according to a set of hierarchal rules, updatable, and at least partially installable on the end user computer. The publisher content may include applications and multi-media files stored on the end user computer. The software includes a means for detecting a network connection by the end user computer and automatically updating the publisher's content URLs publisher's if called for by publishing software on a web server on the network. Private e-mail software enables bilaterally authorized communications by way of private e-mail messages between two parties and includes depositing of private e-mail messages in private e-mail boxes containing only private e-mail messages from previously authorized senders who were previously authorized to send private e-mail messages to the private e-mail box or boxes.

### BACKGROUND OF THE INVENTION

1. Field of the Invention

The present invention relates generally to computer systems and software using the World Wide Web (WWW) for publishing, marketing and advertising and, more particularly, to distribution of multi-tier publisher's content through the Web to end users such as customers.

2. Discussion of the Background Art

Business marketing is very desirable of targeting their customers needs and interests as part of their effort to sell products and services. The advent of the global network termed the Internet, called the World Wide Web (WWW or WEB), has opened up an entire new medium for advertising and marketing in conjunction with entertainment, educational and business information and services available to end users. An important aspect of advertising on the Web is control of the content and distribution of the advertising materials. Another important aspect is access to customers and potential customers and control of such access. This is particularly true if distributers or dealers are in the sales chain between the manufacturer and the customer such as the automotive and large home appliance businesses.

Businesses market products and services by advertising such as by placing a classified advertisement on a computer database system. These networks and on-line services like Prodigy and AOL offer these classified services. These systems usually place the advertisement into a category or sub-categories. This method allows the end user to browse through a certain category to view the classified advertisement or an advertisement is directly displayed on a screen such as a banner advertisement. These types of systems don't target customers well enough to increase the customer's interest or opportunity to view, participate in the business's targeted advertising efforts. These advertising systems are also expensive and limited to advertisements and marketing content of a single publisher or advertiser. It is, therefore, highly desirable to have a seamless and easy system of distributing marketing and advertising information or content for several related publishers or advertisers. At the same time, it behooves a higher tier publisher to control the advertising or marketing content of lower tier publishers or advertisers. It is also useful to enable an end user or customer's browser to use the content both on-line when connected to a network such as the World Wide Web (Internet) or intranet and off-line when not connected to a network. It is also desirable to provide up-to-date sales and marketing information and useful utilities and functions as well as advertising information to the customer in a fashion that will not interfere with the end user operations, will not unnecessarily use his time, and will enhance the customer's experience of using the Internet and encourage the end user to use the browser.

In addition to marketing, other types of web publishing is used for communications between various levels of organizations or between different organizations. Fast, reliable, uncluttered messaging capability is highly desirable. E-mail across a network such as the Internet or on an intranet or extranet has many problems. One major problem is unwanted e-mail which not only clogs up the e-mail system but makes it difficult for e-mail recipient to see truly important messages that the recipient may be waiting for or is from a high priority customer, supplier, manager, etc.

### SUMMARY OF THE INVENTION

Multi-tier publishing software is stored in machine readable format for distribution by a third party publisher to be used by an end user on an end user computer having a fixed storage means and interface with a web server using a network. The software is stored electronically, typically, in a compressed format and loaded onto the end user computer. The multi-tier publishing software includes URL's and publisher's content of tiered publishers that is at least partially controlled according to a set of hierarchal rules, updatable, and at least partially installable on the end user computer. The publisher content may include applications and multi-media files stored on the end user computer.

The software includes a means for monitoring end user behavior and maintaining a local event statistics database of the end user behavior including event data related to end user events. Such end user behavior includes end user behavior on-line and viewing locally stored files on the end user computer off-line. The software includes a means for detecting a network connection by the end user computer and automatically updating the publisher's content URLs publisher's if called for by publishing software on a web server on the network. The invention provides multi-tiered publishing software, method, and systems that can be controlled by distributors and tiered publishers across the web or other network.

Another feature of the multi-tiered publishing software, method, and systems disclosed and claimed herein is private e-mail method, system, and software. Private e-mail is sent and received through a private e-mail channel communication server connected to a network such as the Internet. The private e-mail software provides bilaterally authorized communications by way of e-mail between two parties, depositing of private e-mail messages in private e-mail boxes containing only private e-mail messages from previously authorized senders who were previously authorized to send private e-mail messages to the private e-mail box or boxes.

### BRIEF DESCRIPTION OF THE DRAWINGS

The novel features believed characteristic of the present invention are set forth and differentiated in the claims. The invention, together with further objects and advantages thereof, is more particularly described in conjunction with the accompanying drawings in which:

FIG. 1 is an exemplary embodiment of an organization chart of publishers using a multi-tier publishing software.

FIG. 2 is a block diagram illustrating an exemplary embodiment of a system for employing WEB based multi-tier publishing software, method, and system of the present invention.

FIG. 3 is a first HTML page illustrating a screen for an exemplary automobile service record application window for a first tier publisher.

FIG. 4 is a first HTML page illustrating a screen for the exemplary automobile service record application window for a second tier publisher.

FIG. 5 is an illustration of a Microsoft Windows Desktop screen having an application icon for the application in FIG. 3.

FIG. 5A is an illustration of a Microsoft Windows Desktop screen having a lower tiered publisher's application icon for the application.

FIG. 5B is an illustration of a Microsoft Windows Desktop screen having a different tiered publisher's application icon for the application.

FIG. 5C is an illustration of a second HTML page illustrating a screen for the exemplary automobile service record application window for a different tiered publisher's publisher.

FIG. 6 is an illustration of an exemplary embodiment of a first data entry window used to enter information about the first tier publisher or master brandholder.

FIG. 7 is an illustration of an exemplary embodiment of a second data entry window used to enter information about the first tier publisher or master brandholder.

FIG. 8 is an illustration of an exemplary embodiment of a third data entry window which is an alternative to the second data entry window used to enter information about the first tier publisher or master brandholder.

FIG. 9 is an illustration of an exemplary first account management screen used to create a second tier publisher or brandholder.

FIG. 10 is an illustration of an exemplary second account management screen used to create rights of second tier publisher or brandholder.

FIG. 11 is an illustration of an exemplary first account statistical report management screen used for accessing statistical report software by a second tier brandholder or publisher.

FIG. 12 is an illustration of an exemplary second account statistical report management screen used for accessing statistical report software by a third tier brandholder or lower level brandholder or publisher.

FIG. 13 is an illustration of an exemplary alternative end user installation window of the software contained on a CD-ROM distributed by one of the brandholders.

FIG. 14 is an illustration of an exemplary database application with exemplary banner and drop down hotlinks menu with exemplary navigation hotlinks.

FIG. 15 is an illustration of an exemplary application icon 50 with a changed appearance.

FIG. 16 is an illustration of an exemplary alternative end user installation window of the software contained on a CD-ROM distributed by one of the brandholders if no serial number is entered into the serial number box.

FIG. 17 is an illustration of an exemplary database application with exemplary default banner and drop down hotlinks menu for the first exemplary tier brandholder.

FIG. 18 is an illustration of the application icon for the first exemplary tier brandholder.

FIG. 19 is an illustration of a private e-mail system for sending and receiving private e-mail through the network between senders and recipients.

FIG. 20 is an illustration of a communication banner using private e-mail software for sending and receiving mail through the network between various tiered publishers and/or end users.

FIG. 21 is an illustration of a drop down private e-mail menu that appears when a private e-mail button in the communication banner is clicked.

FIG. 22 is an illustration of a private e-mail list for private e-mail sent via special identification addresses used with private e-mail software.

FIG. 23 is an illustration of a tray icon which is installed on the a tray in a Microsoft Windows Desktop screen.

FIG. 24 is an illustration of an exemplary hierarchy of three tiers of publishers for a security system for federal, state, and local publishers.

FIG. 25 is an illustration of an exemplary user information form for use with the security system illustrated in FIG. 24.

FIG. 26 is a flow chart illustration of an exemplary verification system to validate the registration from the user information form illustrated in FIG. 25.

FIG. 27 is an illustration of an exemplary alert icon on an desktop screen used with the security system illustrated in FIG. 24.

FIG. 28 is an illustration of an exemplary private e-mail icon used with the security system illustrated in FIG. 24.

FIG. 29 is an illustration of the exemplary private e-mail icon illustrated in FIG. 28 indicating a changed color and blinking.

FIG. 30 is an illustration of an exemplary a verification banner used with the verification system in FIG. 26.

### DETAILED DESCRIPTION

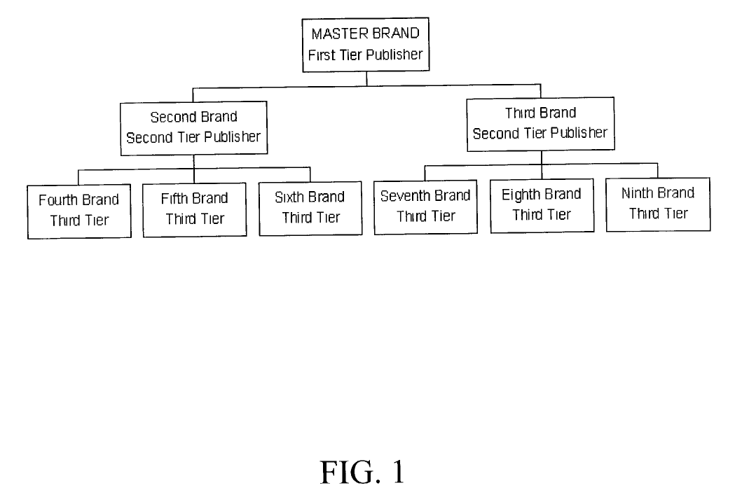

Illustrated in FIG. 1 is an exemplary embodiment of an organization chart 4 of the publishers in multi-tier publishing or marketing software of the present invention. The chart 4 illustrates the hierarchal relationship of multi-tiered publishers exemplified by first, second, and third tier publishers. The publishers will be illustrated as businesses and as is customary in industry today as brands. The lower tier publishers are subject to rules set by an upper tiered one of the publishers within the marketing software. The publishers may be marketers such as manufacturers, distributors, dealers, stores, wholesalers, and service providers such as insurance or medical to name but a few.

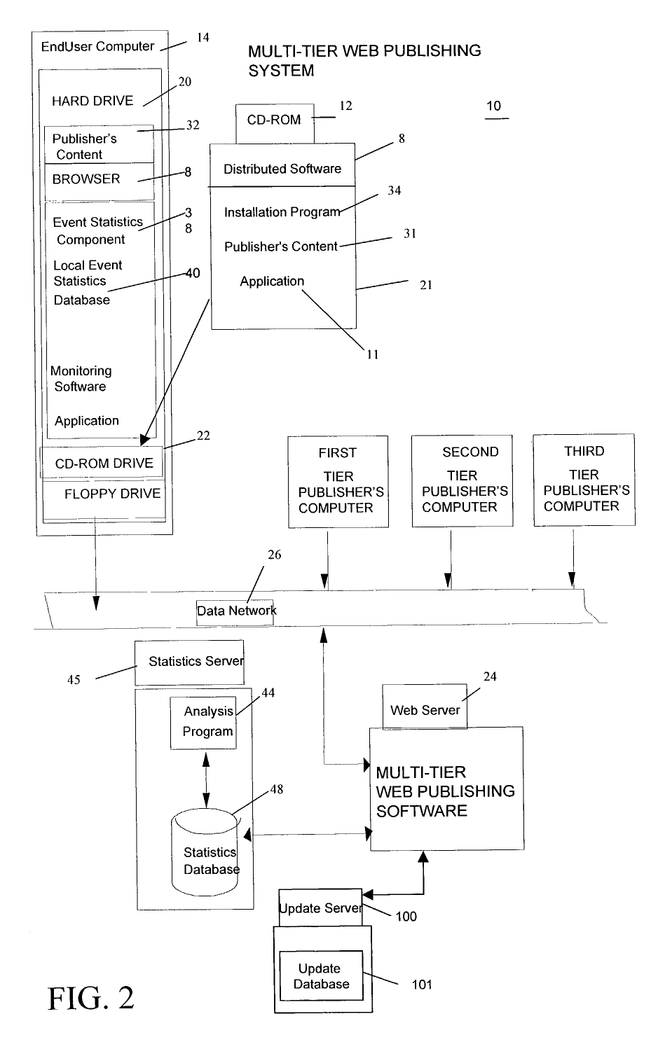

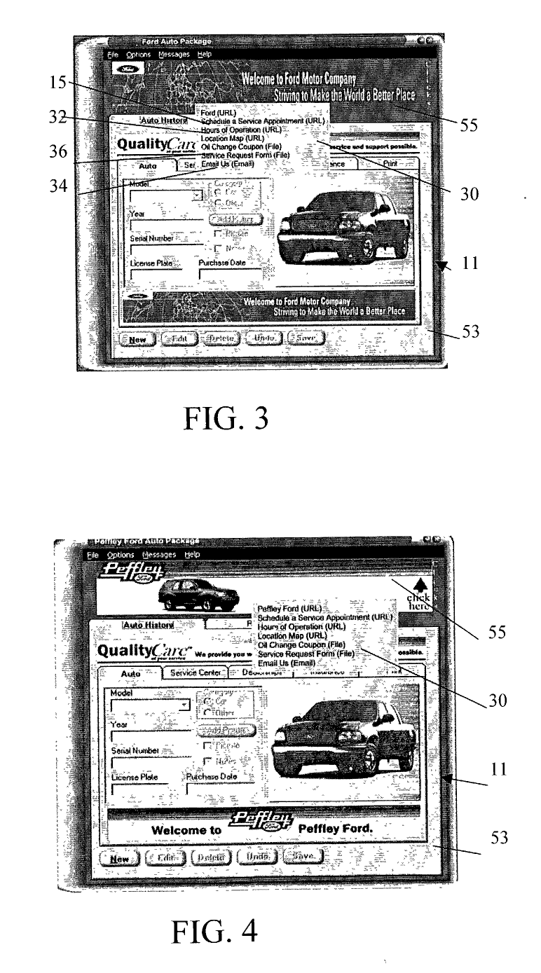

Illustrated in FIG. 2 is a networked web publishing system 10 including multi-tiered publishers distributed software 8 of the present invention illustrated herein as it may be used for business such as in multi-tier marketing. The exemplary illustration is for an automobile company such as Ford illustrated in FIGS. 3 and 4 as the first tier publisher or brand name. A second tier publisher can be a local automobile dealership illustrated as Peffley in FIG. 4. Third tier publishers can be local tire stores, gasoline stations, and insurance agencies. Each of the first, second, and third tier publishers can interface with the end user over the network, through a publishing server, or their own first, second, and third tier publisher's servers, respectively.

The multi-tiered publishers distributed software 8 is used by an end user on an end user computer 14 which is typically a PC or personal computer. The end user computer 14, typically, includes a fixed storage means such as a hard disk drive 20 and a removable storage means such as a floppy disk drive or a CD-ROM drive 22 for retrieving files from the CD-ROM 12. The end user computer 14 interfaces with a publishing network server such as a Web server 24 through a network 26 such as the Internet with a modem or direct connect to the network server or another type of network such as a LAN or intranet.

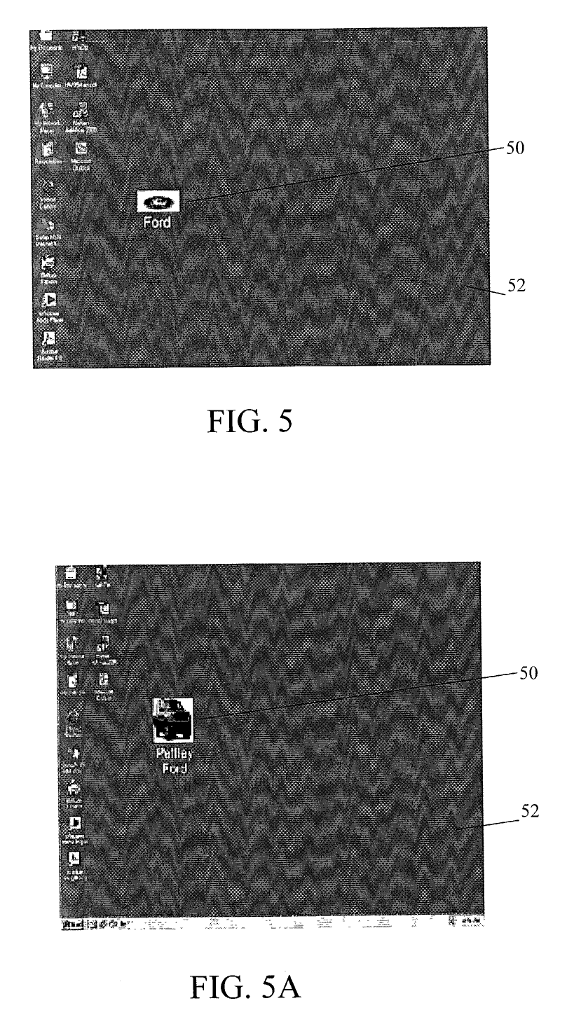

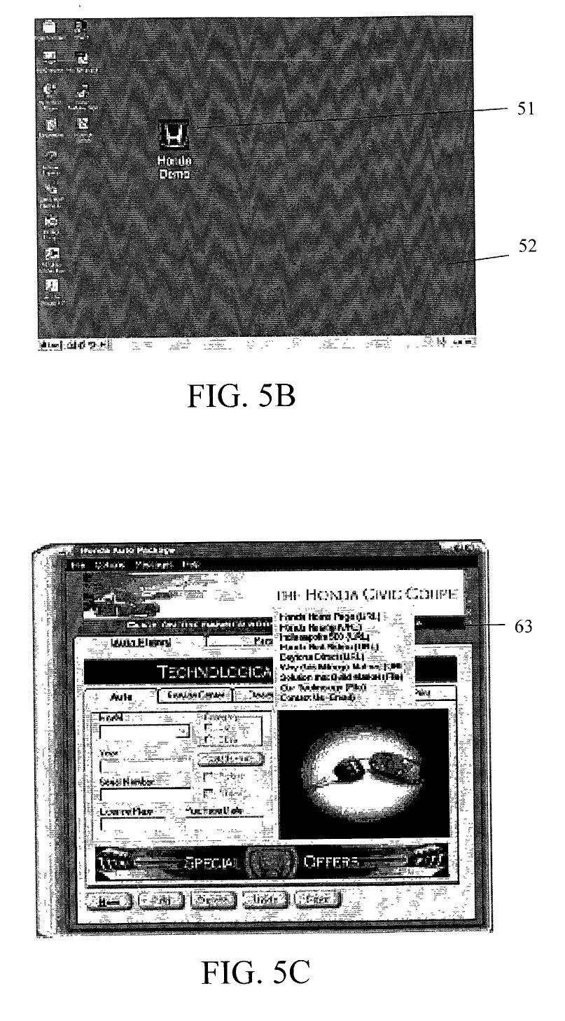

Referring to FIG. 2, the first tier publisher assembles a distribution package 21 for distributing the marketing software 8. The distribution package 21 may be assembled on a publishing computer or server such as the Web server 24 and then distributed on media such as a CD-ROM or through the network such as the Internet. The assembly may be done by a publisher using a publisher's computer over the network such as the internet. The exemplary embodiment of the marketing software 8 package includes at least one application 11. The application and an application icon 50, illustrated in FIG. 5, is installed on the end user computer from the CD-ROM or other means. The application icon 50 labelled FORD appears in a Microsoft Windows Desktop screen 52 or other screen as illustrated in FIG. 5. The application 11 is invoked by clicking on the application icon 50 which launches the application.

Application 11 is illustrated in FIGS. 3 and 4, as an application window 53 for an exemplary stand alone automobile service record application having an exemplary clickable advertising banner 55 denoting the major brand holder or first tier publisher which is illustrated as Ford in FIG. 3. The application contains publisher content that may include useful information, links, as well as performing useful operations on the computer and over the network. The end user may click on the clickable advertising banner 55 and a drop down hotlinks menu 30 containing multiple navigation hotlinks 15 appears within the window. The navigation hotlinks may include a hyperlink 32 to a URL specifying an HTML page on the World Wide Web, an E-mail address 34 allowing the end user quick access to E-mail accounts specified by any of the tiered publishers, and/or the name and location of a file 36 which can be accessed on the end user computer 14, or at some other location on the network. Other types of files or addresses on the network may also be used in the menu of hotlinks.

The second tier publisher is authorized by the first tier publisher and the second tier publisher may have the same right to authorize a third tier publisher with lesser or equal rights as the second tier publisher. Such rights include the right to have one of hotlinks 15 be a link of the tiered publisher's choosing or designation. Other rights may include the right to make updates to the publisher's links, view statistics, and send direct messages. The third publisher probably would have the least amount of rights in the exemplary embodiment illustrated herein. The third tier publisher may purchase rights from the second tier publisher to advertise on a selective portion of the software 8. For example, the third tier publisher could buy a certain number of links on the advertising banner from the second tier publisher. The identity of any of the tiered publishers could change from time to time and sometimes there may not be any third tier publisher while other times there may be more than three tiers of publishers.

Referring to FIG. 3, several fields are included in the window such as the model, year, license plate number, and purchase date of a vehicle presumably bought or serviced at a dealer of the primary brand holder or first tier publisher, Ford. Ford can authorize rights to the dealer and the rights and necessary files may be included in the distribution package 21 which is distribute to dealer customers, which are the end users, on media such as the CD-ROM with which the end user installs the application 11 on the end user computer. The end user may then chose to display the application with advertising information and hotlinks 15 belonging to the second tier publisher, which is the dealer in this example, by entering an identification number ID such as a serial number in the box labelled serial number in FIG. 3. One likely method of distribution of the distribution package 21 is the dealer giving the end user the CD-ROM together with the serial number which is particular to each dealer. Any lower tiered publisher can use this method.

The application 11 window in FIG. 4 illustrates how the application looks on the end user computer when the serial number, in this example for a dealership, has been entered as illustrated above. A new clickable advertising banner 55 appears in the window and at least some new navigation hotlinks 15 appear in the drop down menu. Some of the navigation options are the URLS or other navigation options belong or are controlled by the first tier publisher. The other navigation options belong or are controlled by the second tier publisher. Optionally, the second tier publisher might assign or authorize some of navigation hotlinks 15 to one or more lower tiered publishers. This may just be in the form of a link to an advertisement or it may be a URL location to a website belonging to a lower tiered publisher. A new application icon 50 illustrated in FIG. 5A as being titled Peffley takes the place of the FORD titled application icon 50 in the Microsoft Windows Desktop screen 52 illustrated in FIG. 5.

Other publishers such as manufacturers may be authorized and added later by the end user by entering authorized serial numbers of other publishers using the same application with different the same or different graphics. One example is illustrated in FIGS. 5B and 5C for Honda. A Honda icon 51 as illustrated in FIG. 5B appears in the Microsoft Windows Desktop screen 52 when an authorized Honda serial number is entered by the end user. After the Honda icon is clicked by the end user a Honda application window 63 appears on the end user's computer screen as illustrated in FIG. 5C. Thus one application and master publisher can authorize many different lower tier publishers to use the same appliactions and operate through the same web server.

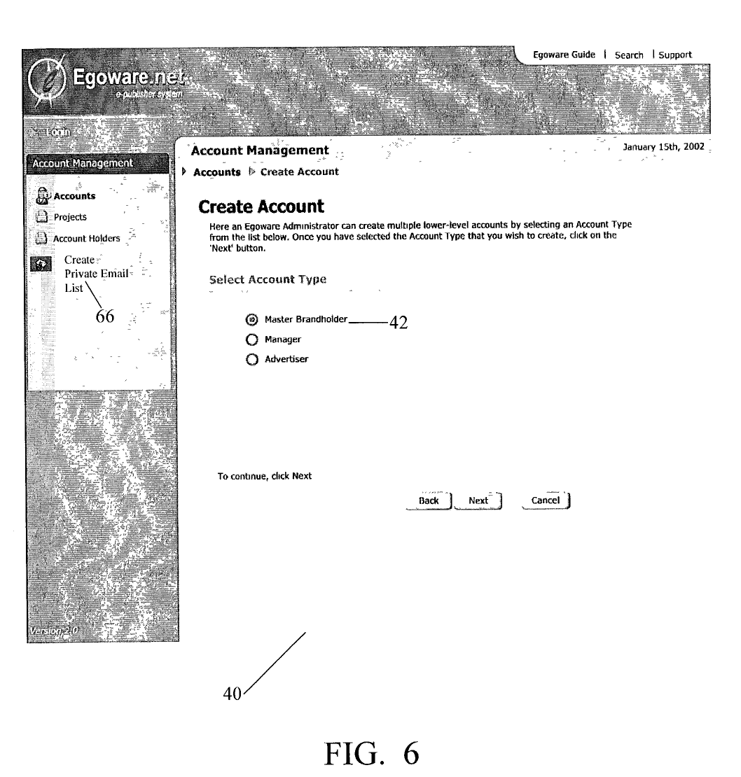

FIGS. 6-8 illustrate one exemplary system that may be used to create a master or first tier brandholder or publisher and lower tier or multi-tiered publisher's accounts. The master brand holder or first tier publisher either uses or acts as a publishing administrator to create a master brandholder account by logging into an account control center and control software which, in this embodiment of the invention, is on the Web server 24 but can be on any computer. Illustrated in FIG. 6 is an exemplary embodiment of a first data entry window 40 that is used by the administrator to enter information about the first tier publisher or master brandholder. Alternatively, the account control center may be set up so that the master brandholder or the first tier publisher may log onto the Web server 24 through the network or internet and open a master brandholder account by logging into the account control center.

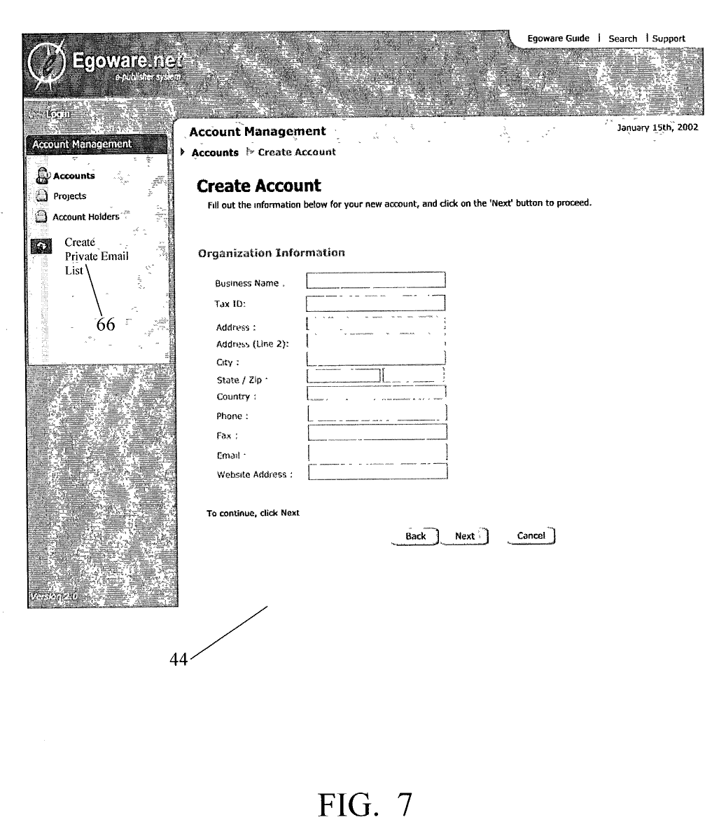

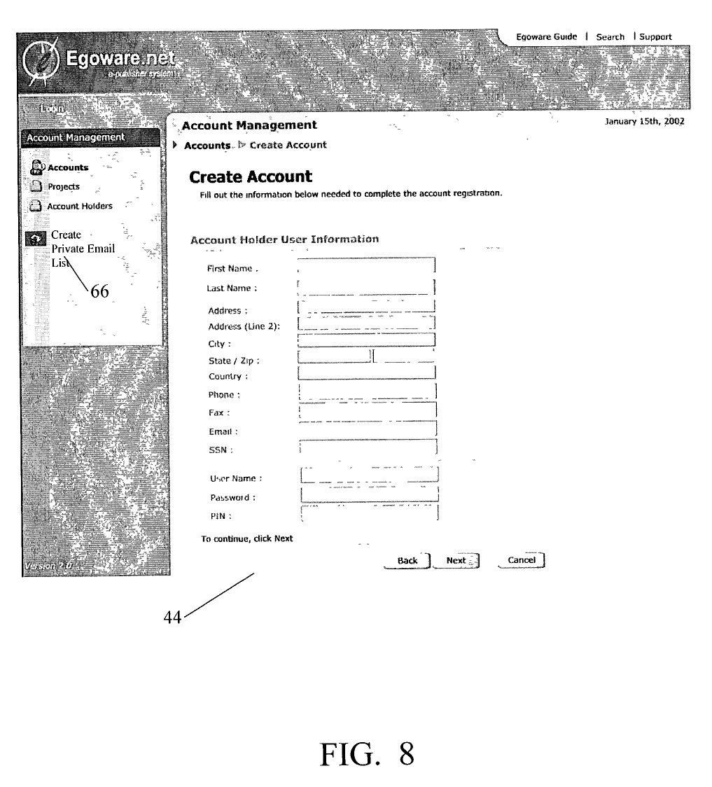

The type of account 42 to be created is designated in the window in FIG. 6. In this case, it will be the master brandholder. Information about the master brandholder is entered in a second data entry window 44 illustrated in FIG. 7. The exemplary embodiment includes fields for entering data such as the master brandholder's business name, address, e-mail address, website address or URL, and phone and FAX numbers. FIG. 8 illustrates other possible fields which include a username, PIN (personal identification number, a password, in a third data entry window 46, which is an alternative to the second data entry window in FIG. 7. Information for an individual contact may be included such as first and last names, address, and social security number (SSN) may also be included in these fields.

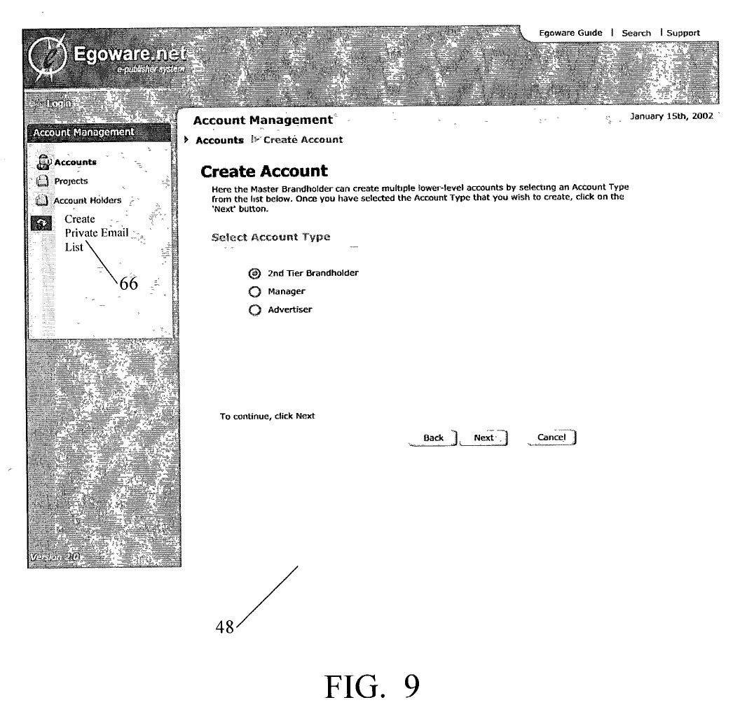

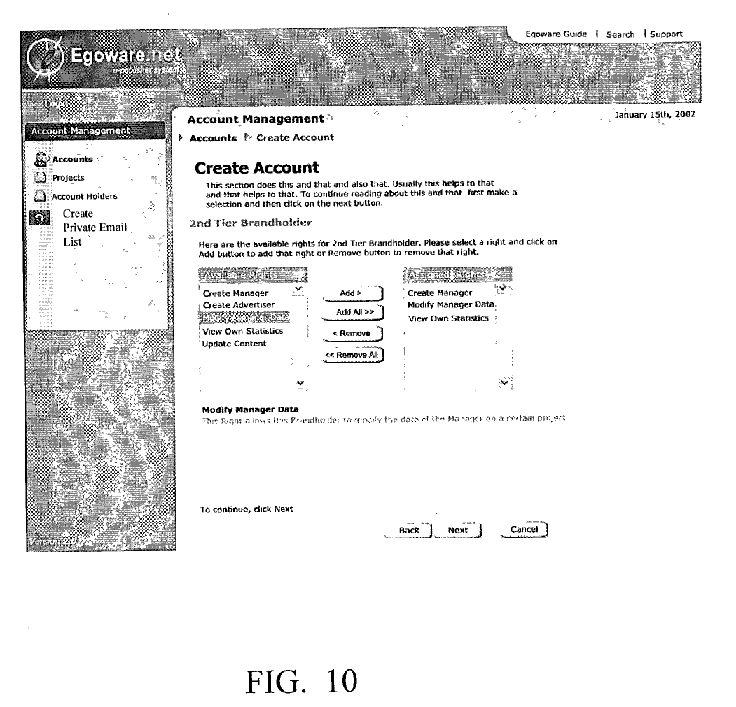

Once a master brandholder account is created, the master brandholder may have rights to create multiple lower tier accounts if the master brandholder was granted permission or such rights by the entity which created the master brandholder account. The creation of lower tier publisher's accounts by the master brandholder is accomplished by the master brandholder logging onto the account control center and into the control software. This will be bring up account management screens such as a first account management screen 48 illustrated in FIG. 9 used to create a second tier brandholder account. The second tier button is clicked and then the next button is clicked which brings up the window illustrated in FIG. 7. Then the same type of information about the second tier brandholder is entered as described for FIG. 7 above and next the same type of information for the window in FIG. 8 as described above. After these two windows of information are completed and the next button is clicked upon a window illustrated in FIG. 10 is brought up. Another feature illustrated in FIGS. 6-10 is a private email list button 66 for authorizing recipients allowed to send and/or receive private email as disclosed further herein.

The window in FIG. 10 is used to assign rights to the second tier brandholder. Five different types of rights are illustrated in FIG. 10 though other types of rights can be made available. These rights include the right to create a manager, create an advertiser, modify manager data, view own statistics, update content (which can includes on-line available over the internet or content stored on the end user computer. One of the rights listed in a left hand column labelled available rights is highlighted by clicking on it and then by clicking on add button it is transferred to a right hand column labelled available assigned rights. When the list of assigned rights is completed the next button at the bottom of the window is clicked.

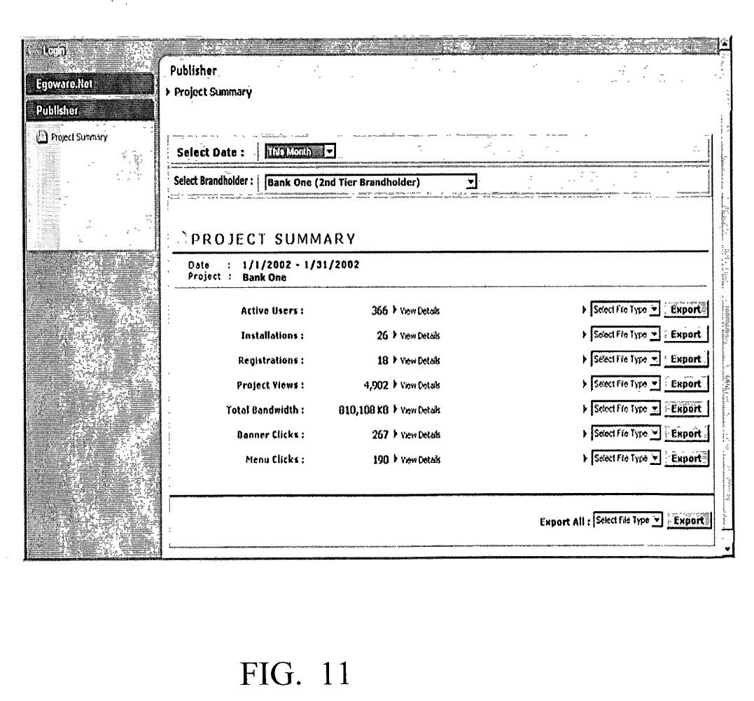

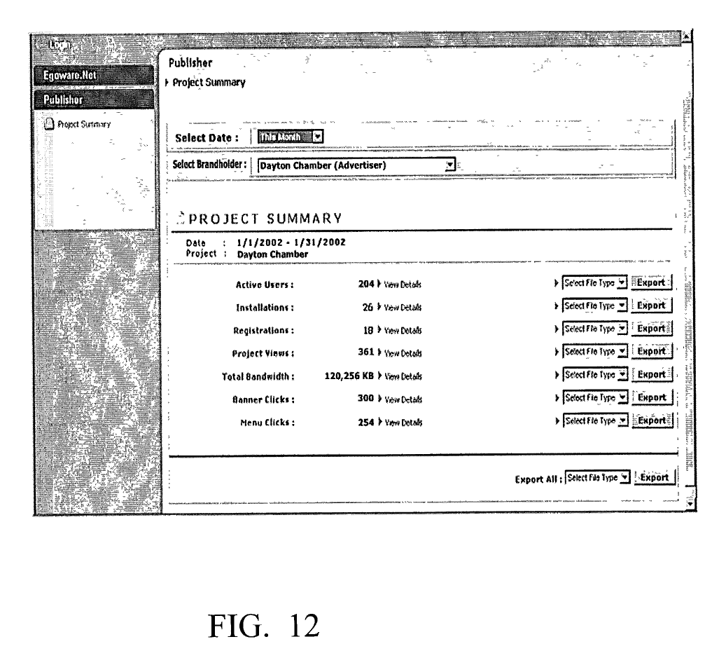

The present invention also includes statistical report software that may be stored on the publisher's computer. FIG. 11 presents a screen window which illustrates how the statistical report software may be accessed by a second tier brandholder through the control software. FIG. 12 presents a screen window which illustrates how the statistical report software may be accessed by a third tier brandholder, an advertiser, through the control software. Some of the possible statistics that may be recorded on the end user computer and on the publisher's computer include number of active users, installations, registrations, banner clicks, and menu clicks and total band width. The reports are set up as projects and reports may be viewed for different brandholders by clicking a brandholder in a brandholder menu box. The master brandholder can view more detailed statistics by clicking on “View Details” button next to the numbers. These statistics may also be exported to a database or other type of file if so desired by pressing an export button for any or all of the statistics.

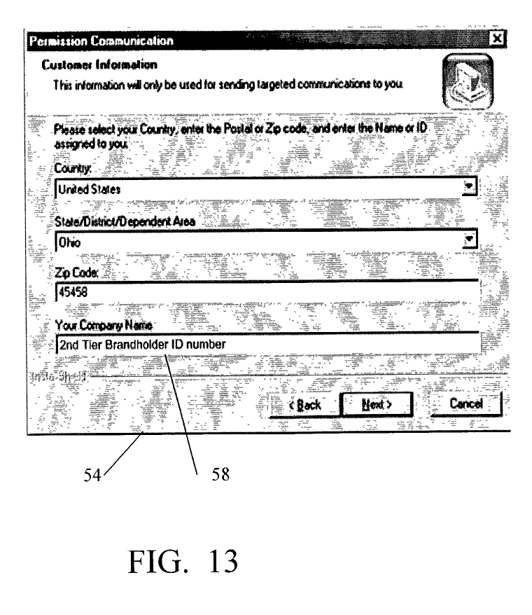

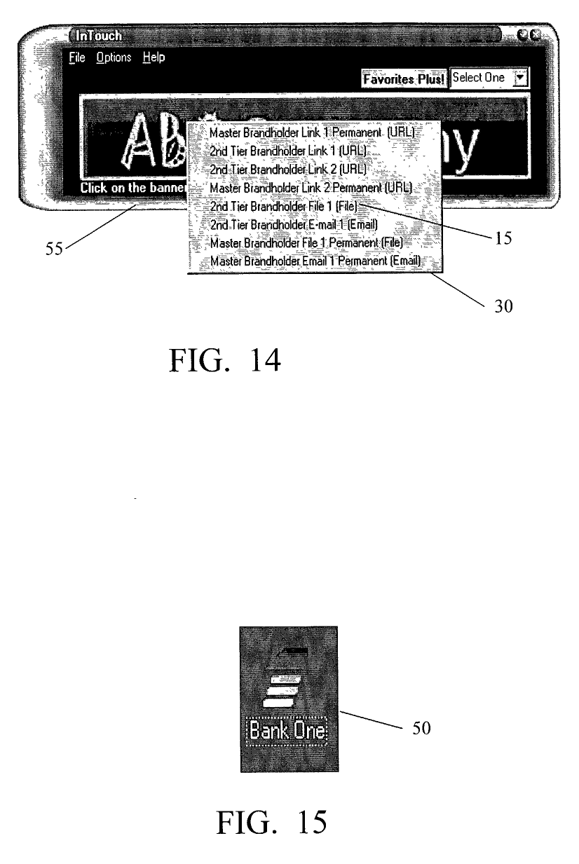

FIG. 13 illustrates an alternative end user installation window 54 of the software contained on a CD-ROM distributed by one of the brandholders. The end user installs an application, which includes a brandholder banner, on the end user computer from a CD-ROM. The application illustrated in FIGS. 14 and 17 is titled “Favorites Plus” and is database application for URL's that have been visited on the network or WEB. The end user may then choose to display the application customized for any brandholder by entering an identifier such as an ID number or a serial number such as “2nd Tier Brandholder ID Number” given to the end user by that particular brandholder in a serial number box 58 labelled Your Company Name in this example. Note that the serial number box 58 may have more than one field for multiple identifiers of associated brandholders.

FIG. 14 illustrates the banner 55 and the navigation hotlinks 15 displayed include the hotlinks authorized for brandholder and by the brandholder of the associated ID number entered by the end user. The drop down hotlinks menu 30 containing the multiple navigation hotlinks 15 is displayed by the end user clicking on the banner 55 as per instructions at the bottom of the banner. Illustrated in FIG. 15 is the application icon 50 which changes appearance to one associated with the particular brandholder whose serial number was entered into the serial number box labelled “Your Company Name” as illustrated in FIG. 13.

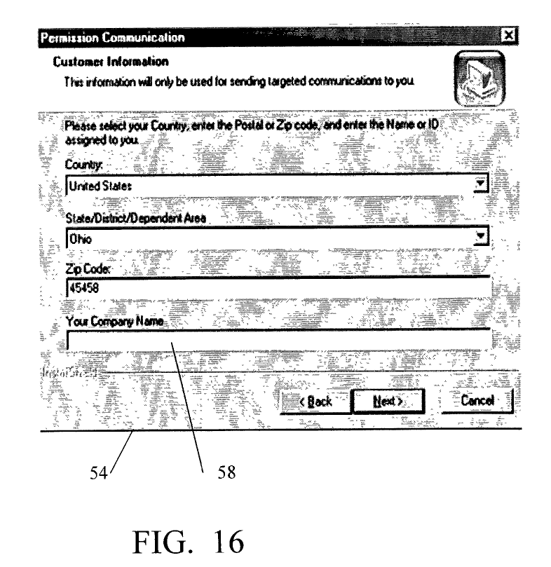

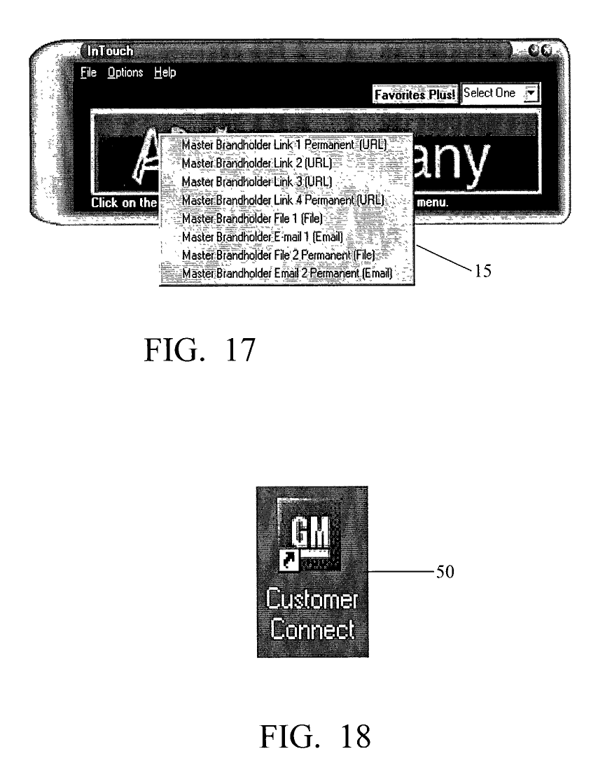

If no serial number is entered into the serial number box as illustrated in FIG. 16 the banner and the navigation hotlinks displayed default to the banner and hotlinks of the first tier brandholder as illustrated in FIG. 17 and the appearance of the application icon 50 remains one associated with first tier brandholder as illustrated in FIG. 18. The banner is like a billboard for advertising the tiered brandholder or publisher. Note that though the second tier brandholder's links are displayed in the link pulldown window there are also some links from the first tier or master brandholder displayed. These are links which the master brandholder made permanent when he set up the system and authorized rights to the lower tier brandholders. The master brandholder has the right to make any number of his links permanent so that no matter how many lower tier brandholders are authorized, his links will still be displayed.

One or more advertisers can be given various advertising rights by various brandholders. For example, an advertiser may pay one of the brandholders to have the advertiser's link or links displayed on the billboard in the drop down menu containing multiple navigation hotlinks 15. No other rights are given to this advertiser. The master brandholder may acquire a first tier advertiser and display this advertiser's link or links in navigation hotlinks 15 which he has set as permanent. A second tier brandholder may acquire an advertiser that is only permitted to display links for which he was granted the right to display by the master publisher and only to the extent granted by the master publisher. One example of this right may be two links and one advertiser link.

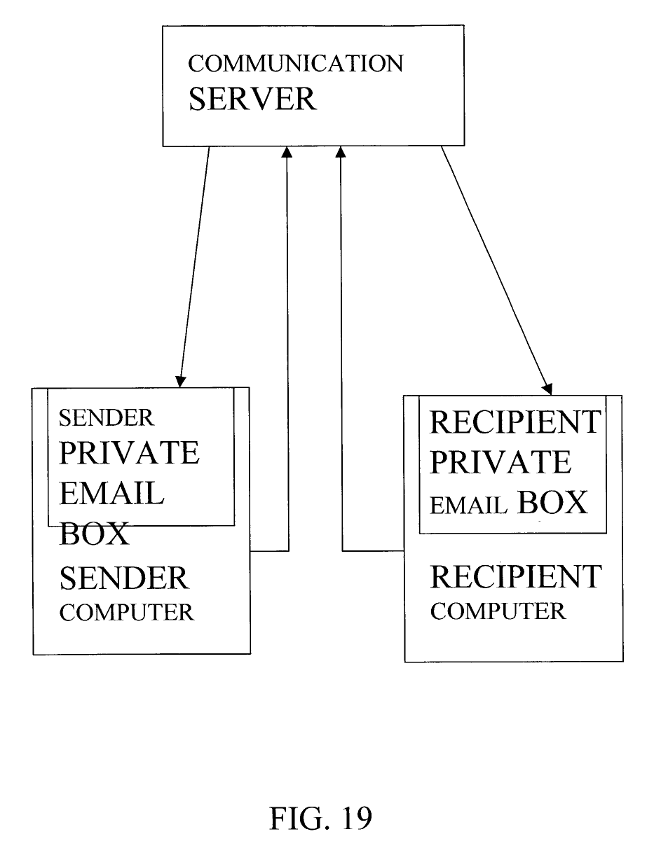

FIG. 19 illustrates a system using private e-mail software to send and receive private e-mail through the network enabling a sender such as an upper tier publisher or brandholder and a recipient such as an end user, lower tier publisher, or brandholder to communicate back and forth through a secure, private e-mail channel. The private e-mail is sent back and received through a private e-mail channel communication server such as the Web server 24 connected to the network 26 such as the Internet as illustrated in FIG. 2. The private e-mail software provides bilaterally authorized communications by way of e-mail between two parties, depositing of private e-mail messages in private e-mail boxes containing only private e-mail messages from previously authorized senders who were previously authorized to send private e-mail messages to the private e-mail box or boxes. When an application using the private e-mail software is opened it determines if the end user computer is connected to a network such as the internet and connects to the private e-mail channel communication server.

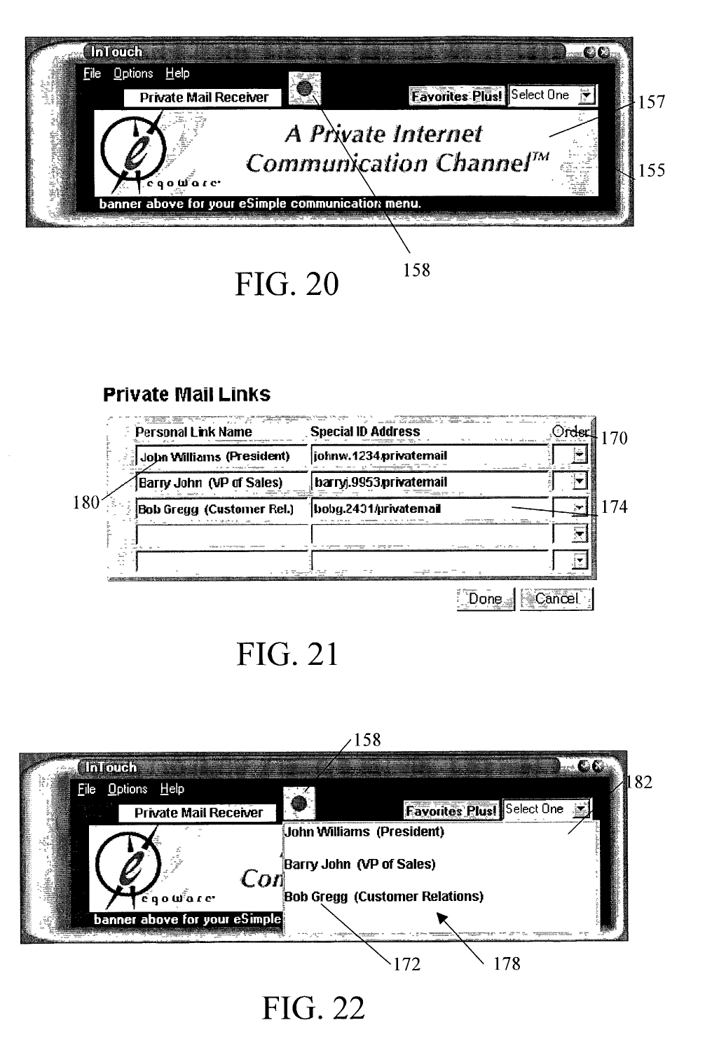

A communication banner 155 is illustrated in FIG. 20 which exemplifies a stand alone communication application denoted as “A Private Internet Communication Channel”. A private e-mail button 158 such as private e-mail receiver illustrated in FIG. 20 is used to launch the private e-mail software alternatively the private e-mail software may be setup such that clicking on the interior 157 of the communication banner 155 launches the private e-mail software. Personal identifiers or identification numbers (IDs) are generated by the application and sent back to the communication server. The administrator through a manual data entry process or an automatic process either issues acceptance or not for end users and lower tiered publishers and brandholders to be on the private e-mail channel and be authorized to receive and/or send private e-mail.

The private e-mail software may also be part of other software or applications such as the marketing software 8 and the private e-mail button 158 maybe be located in the application window 53 such as on the advertising banner 55. Illustrated in FIG. 21 is a drop down private e-mail menu 170 that appears when the private e-mail button 158 is clicked. The private e-mail menu 170 displays a private e-mail list 174 of recipients 180 which are people and organizations that can be communicated with using the private e-mail software and is maintained by and used by the private e-mail user. Typically all recipients on the list have the ability to return private e-mail messages but there may be applications where not all recipients on the list have the ability to return private e-mail messages. The private e-mail addresses are created and stored by one of the tiered publishers or any user of the stand alone private e-mail software which may be part of an application. For example, an end user such as a customer may have two way private e-mail with one or more of the tiered brandholders or publishers but to have the right to create or edit a private e-mail list 174. The private e-mail does not go through a Simple Mail Transport Protocol (SMTP) based e-mail server such as the common UNIX Send mail program which uses the e-mail address on the end user internet provider. The private e-mail is sent according to special ID addresses displayed for personal link names of the recipients 180 listed on private e-mail list 174 in FIG. 21 and stored in private e-mail boxes or files on the recipient's computer. The special ID addresses are not stored or communicated on the internet and therefore cannot be copied by other users of the internet. The private e-mail messages are not delivered to the end users e-mail provided to the end user such as by the end user internet provider by which the end user accesses the internet.

After a private e-mail message is received using the Private e-mail software, the private e-mail button 158 (which can also be a private e-mail icon) on the receiver end user computer screen will alter its appearance such as by flashing as indicated in FIG. 22. The altering of the appearance of the private e-mail button is one means of alerting the recipient that private e-mail has been received. The button will continue to flash until the Private e-mail Message Box has been opened by the recipient of the message. When the recipient clicks on the Private e-mail button, a list of private e-mail messages 178 will be displayed such as in a messages drop down menu 182. The list of private e-mail messages may be arranged and described by the names of senders 172.

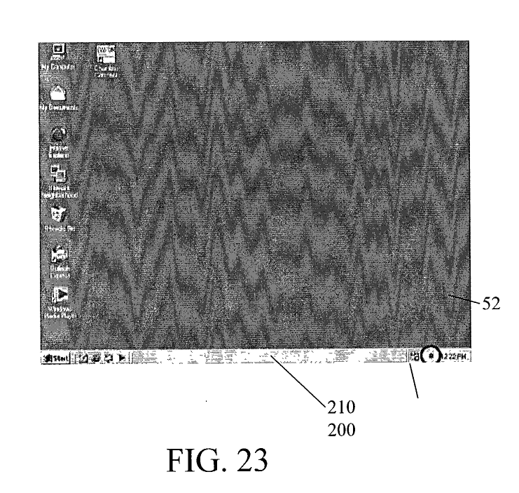

Illustrated in FIG. 23 is a tray icon 200 which is installed on the tray 210 such as a task bar in the Microsoft Windows Desktop screen 52. The tray icon serves as an alternative or additional alerting means. When a product or application receives an update such as a private e-mail message or other changes, messages, or information, the tray icon changes its appearance to show the end user that a change has been made and that there is new information to be seen. If a product has been changed or updated, the desktop application icon changes its appearance and the tray icon flashes or changes its color in the system tray 210. This helps alert the end user that there has been a change to his product or a private e-mail message.

If the end user was using an application while an update was received the desktop icon change would not be viewable but the tray icon is. The flashing tray icon or its changed color on the system tray alerts the end user to such updates or to the receipt of a private e-mail message so that the end user can be informed that there has been a change. The system tray icon will only appear when there has been an update or change. The tray icon does not appear in system tray all of the time like other icons do. Icons that reside on the tray at all times slow a computer down. Once the end user has viewed the new information, the icon will disappear.

A permanent tray icon may be used and it will change its appearance when an update is received. It may flash or change color and then revert to its original appearance after the update has been viewed. Another feature is that the tray icon appears when a private e-mail message has been received and it will flash until the private e-mail message is viewed. The tray icon may be a stand alone feature or software that can be incorporated in many types of communication applications such as e-mail and the private e-mail software disclosed herein.

The private e-mail software and the multi-tier publishing software include a means for detecting a network connection during program start-up and executing a transaction with the web server to determine if updates by any of the tiered publishers have been made. The software further includes a means for updating the publisher's content on the end user computer. Updating the publisher content includes downloading new files from the server and storing them on the end user computer and deleting existing files which are stored on the end user computer. The new content includes messages such as the private e-mail messages. The transaction with the web server includes transmitting at least one of a set of identifying data such as the personal identification number.

Numerous methods are available to employ the private e-mail software to communicate with various recipients including tiered publishers, brandholders, and end users. Customers may be sent private e-mail by merchants, dealers, or manufacturers. Suppliers may be sent private e-mail by manufacturers. Lower level managers may be sent private e-mail by upper level managers. Separate private e-mail boxes may be used for several higher tiered publishers. Multiple stand alone communication applications denoted such as the “A Private Internet Communication Channel” illustrated in FIG. 20 may be opened and the associated communication banners 155 displayed simultaneously. An end user sitting in a meeting can have his computer turned on and connected to an intranet or the internet and send and receive private e-mail messages without disturbing the meeting.

Many types of applications can use the multi-tier publishing software of the present invention and it's hierarchal publishing abilities. The multi-tier publishing software can be applied to situations where varying levels of publishing rights are needed, such as companies, government agencies, etc.

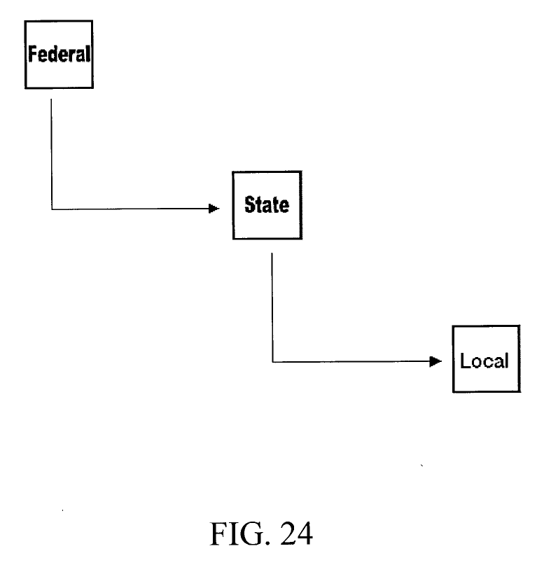

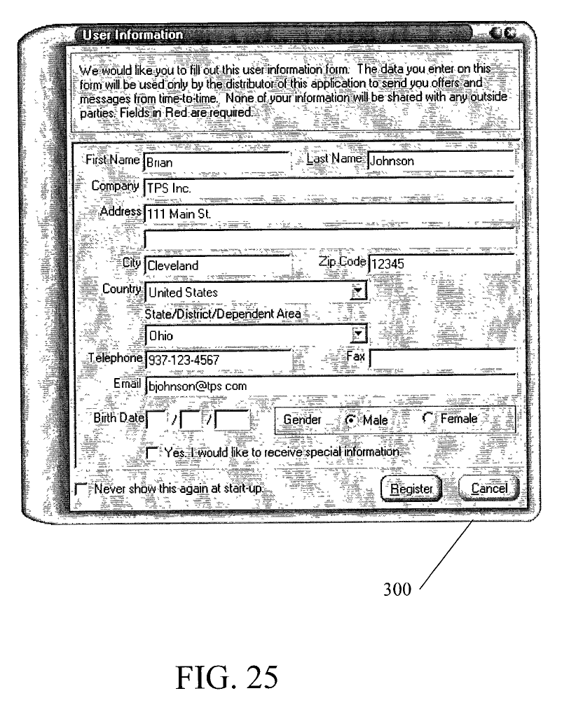

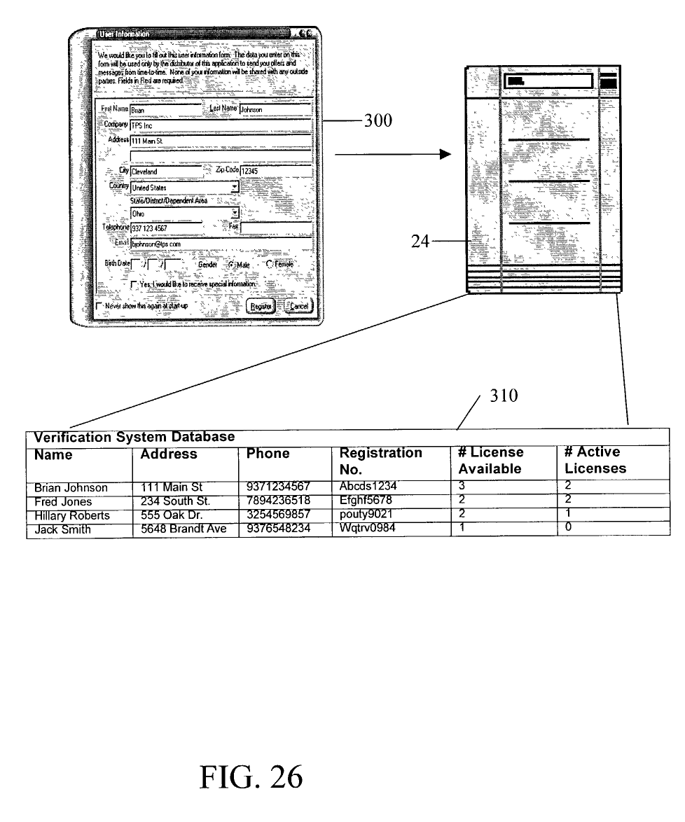

One particular application that uses the multi-tier publishing software is a government or private security application such as a national security application illustrated in FIGS. 24-30. FIG. 24 illustrates three tiers of publishers and end users which are denoted as federal, state, and local. The local publisher tier may include municipalities, counties, towns, agencies, individuals, companies, etc. A window containing an exemplary user information form 300, illustrated in FIG. 25, is filled out for each end user or lower tier publisher. The user information forms are sent out first by the top tiered publisher which could be a federal agency to individuals or lower tiered agencies, individuals, and companies. One master federal agency can send it out to other federal agencies and there may be four or more tiers of publishers in the system. Upon completion of the user information form 300, data entered into the form is be sent to a verification system to validate the registration as illustrated in flow chart form in FIG. 26. The verification system including a verification system database 310 is maintained on a publisher's server such as the Web server 24 described above. If the data is validated, the application will receive information. The verification system allows for multiple licenses per software user.

The number of licenses can vary per registered user or publisher. This verification process will occur each time the user attempts to use the application. If at any time an upper tiered publisher wishes to terminate the communication link, the application can be turned off in the verification system. The upper tiered publisher may also have the ability to initiate the uninstallation process on the end user computer. Because the application may have a number of users, this registration will form will be used multiple times.

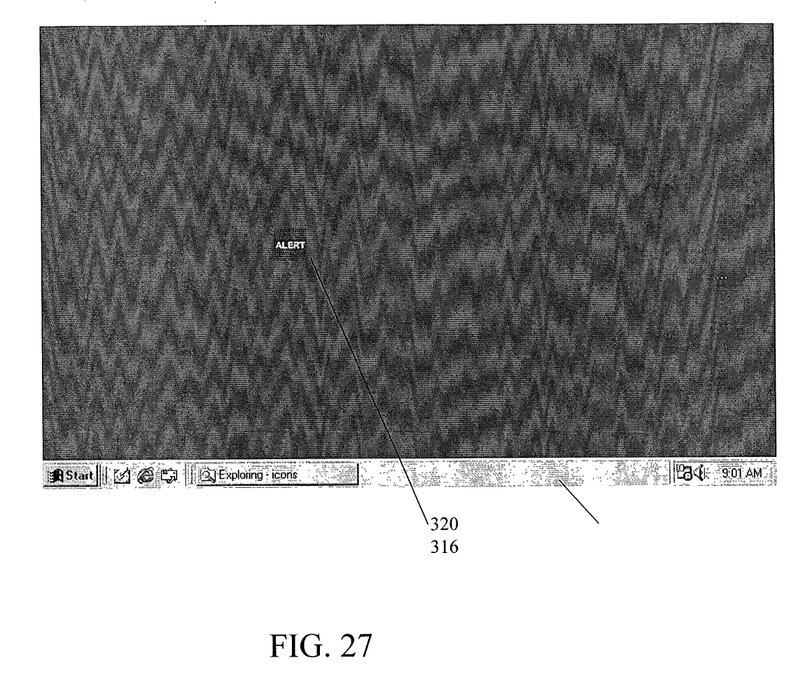

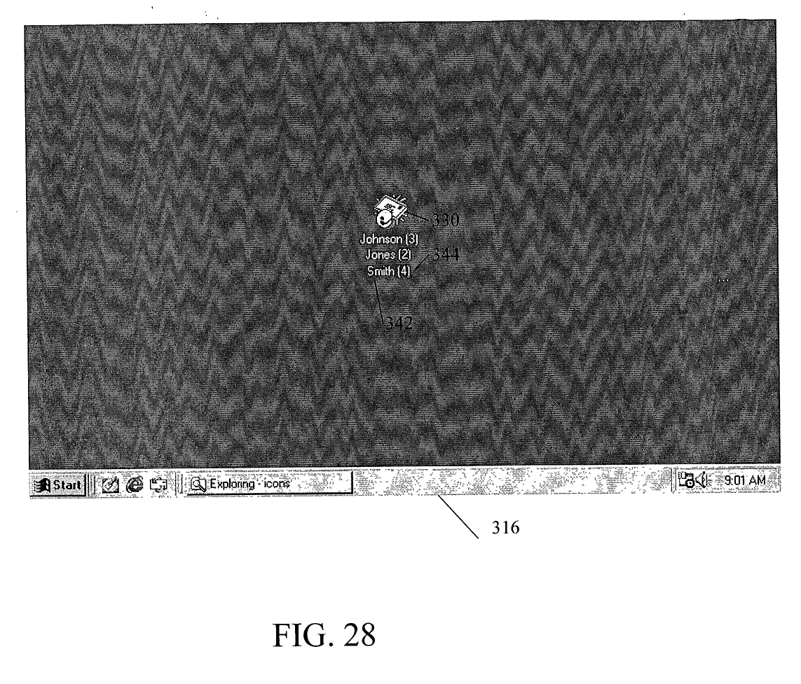

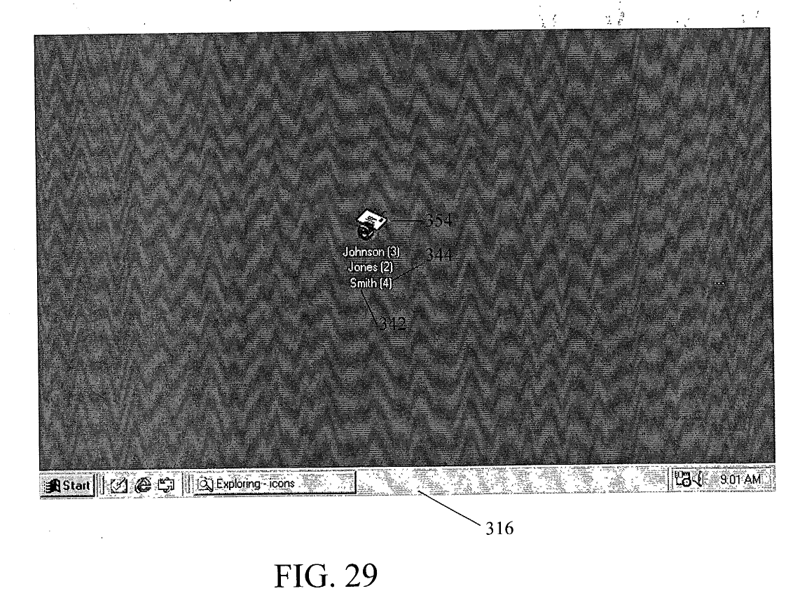

A desktop screen 316 such as the one illustrated in FIG. 27 can display an alert icon 320 which could change color based on the actions of only one or of any one of the tiered publishers. The alert icon 320 can blink until the alert change is recognized by the end user using the desktop screen 316. Another exemplary application is a private e-mail icon 330 in FIG. 28 which allows a federal, state, or local publisher to publish new information in a private e-mail message causing the private e-mail icon 330 to change its appearance such as blink or change its color when the new private e-mail arrives in the end user computer. Alerts can be sent out by any one of the three tiers. Another exemplary application of a private e-mail icon 350 in FIG. 29 uses a color changeable icon 354 change its color to indicate a change in security alert status and blink when the new private e-mail arrives in the end user computer.

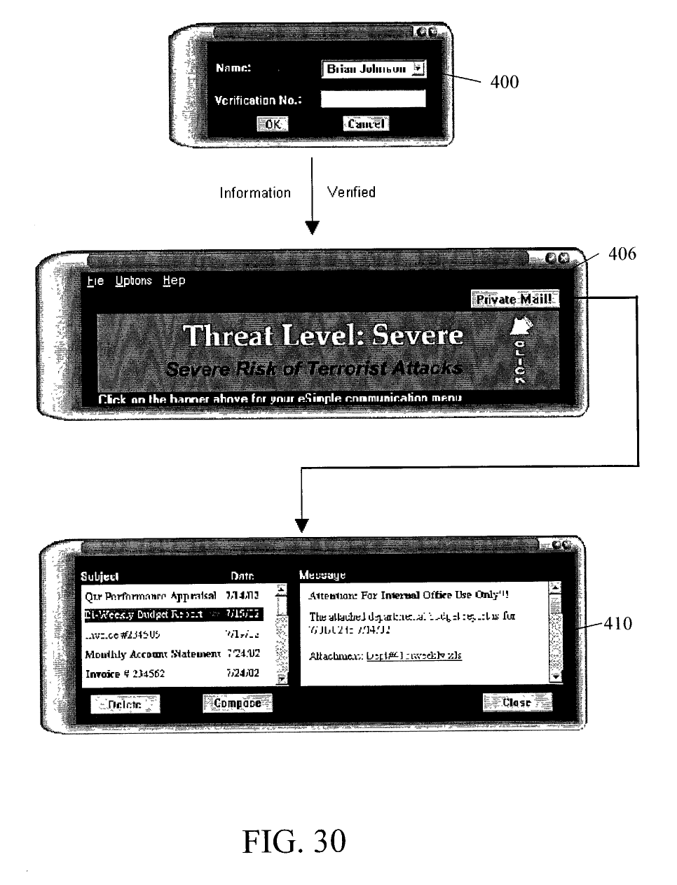

Any private e-mail or direct targeted messages sent to the application by a particular end user or sender will display that sender's name 342 and the number of accompanying messages 344 sent by that sender in an area on the screen associated with the private e-mail icon such as within or under the private e-mail icon as illustrated in FIGS. 28 and 29. The private e-mail icon, which changed appearance to alert that new messages are available, will not change back until all private e-mail and direct targeted messages have been viewed or displayed by the appropriate users. When the recipient attempts to open the application the recipient will be prompted for name and id number such as in a verification banner 400 illustrated in flow chart from in FIG. 30. After the recipient enters the name and id number application information sends the information to the verification system described above to determine if the recipient end user is permitted to view the new content. After receiving confirmation, the application will open the new content illustrated in a content banner 406 and the private e-mail box and private e-mail messages stored within it illustrated in a private e-mail banner 410.

While there have been described herein what are considered to be preferred and exemplary embodiments of the present invention, other modifications of the invention shall be apparent to those skilled in the art from the teachings herein and, it is therefore, desired to be secured in the appended claims all such modifications as fall within the true spirit and scope of the invention.

Accordingly, what is desired to be secured by Letters Patent of the United States is the invention as defined and differentiated in the following claims:

What is claimed is:

1. Multi-tiered publishers distributed software stored in machine readable format comprising:
a menu display means for displaying a menu of tiered navigation options associated with tiered publishers,
the tiered navigation options below a first tier are subject to rules set by an upper tiered one of the publishers, and
at least a portion of the navigation options are URLs on a network to which end user computer is connectable.

2. Distributed software as claimed in claim 1 wherein the menu of tiered navigation options includes at least one tiered set of navigation options associated with one of the tiered publishers.

3. Distributed software as claimed in claim 2 wherein the navigation options further include one or more URLs to files stored on fixed storage means for fixedly storing files on an end user computer.

4. Distributed software as claimed in claim 1 further comprising a navigation option updating means for allowing at least one of the tiered publishers to change one or more of the navigation options stored on the end user computer.

5. Distributed software as claimed in claim 4 wherein the menu of tiered navigation options provided by tiered publishers includes at least one tiered set of navigation options associated with the tiered publishers.

6. Distributed software as claimed in claim 5 wherein the navigation options further include one or more URLs to files stored on fixed storage means for fixedly storing files on an end user computer.

7. Distributed software as claimed in claim 6 wherein the navigation options further include one or more applications.

8. Distributed software as claimed in claim 7 wherein at least one of the applications is stored on the fixed storage means.

9. Distributed software as claimed in claim 8 wherein at least one of the applications is identified as specific to one of the publishers.

10. Distributed software as claimed in claim 6 further comprising a publisher updating means for allowing a relatively higher tiered publisher to change one or more of relatively lower tiered ones of the publishers stored on the end user computer.

11. Distributed software as claimed in claim 10 wherein the publisher updating means and the navigation option updating means includes means for automatically detecting a network connection and executing a transaction with a network server to determine if any of the publishers and any of the navigation options should be updated and a means for updating one or more of the publishers and one or more of the navigation options.

12. Distributed software as claimed in claim 11 wherein the navigation options further include one or more applications stored on the fixed storage means.

13. Distributed software as claimed in claim 12 further comprising an application updating means for allowing one of the publishers to change an associated one of the applications and a means for automatically detecting a network connection and executing a transaction with a network server to determine if any of the applications should be updated and a means for updating one or more of applications stored on the fixed storage means.

14. Distributed software as claimed in claim 13 further comprising an application icon and means to change the application icon's appearance to one associated with a particular brandholder whose identification is entered into the application.

15. Distributed software as claimed in claim 1 further comprising a private e-mail means for sending and receiving bilaterally authorized private e-mail through a network to private e-mail boxes containing only private e-mail messages from previously authorized senders who were previously authorized to send private e-mail messages to the private e-mail box.

16. Distributed software as claimed in claim 15 further comprising a private e-mail menu means for displaying a private e-mail list of recipients that can be communicated with using the private e-mail means.

17. Distributed software as claimed in claim 16 further comprising a means of alerting the recipient that private e-mail has been received.

18. Distributed software as claimed in claim 17 wherein the alerting means is a means to alter an appearance of a private e-mail button on a recipient's computer screen.

19. Distributed software as claimed in claim 18 wherein the means to alter an appearance of the private e-mail button includes flashing the private e-mail button.

20. Distributed software as claimed in claim 17 further comprising a private e-mail listing means for displaying a list of private e-mail messages in the private e-mail box.

21. Distributed software as claimed in claim 20 wherein the private e-mail listing means includes a means for displaying the list of private e-mail messages in the private e-mail box by clicking on the private e-mail button.

22. Distributed software as claimed in claim 17 wherein the alerting means is a tray icon on a recipient's computer screen.

23. Distributed software as claimed in claim 22 wherein the alerting means is a tray icon on a recipient's computer screen.

24. Distributed software as claimed in claim 23 wherein the means to alter an appearance of the tray icon includes flashing the tray icon.

25. Distributed software as claimed in claim 23 wherein the means to alter an appearance of the tray icon includes changing a color of the tray icon.

26. Distributed software as claimed in claim 23 wherein the alerting means is invoked upon receipt of new information by the application and the tray icon appears on a recipient's computer screen when the alerting means is invoked.

27. Distributed software as claimed in claim 26 wherein the tray icon is removed from the recipient's computer screen when the new information is viewed.

28. Distributed software as claimed in claim 27 wherein the means to alter an appearance of the tray icon includes flashing the tray icon.

29. Distributed software as claimed in claim 27 wherein the means to alter an appearance of the tray icon includes changing a color of the tray icon.

30. Distributed software as claimed in claim 29 further comprising a means for displaying a private e-mail icon on the recipient's computer screen and a means for displays a private e-mail sender's name in an area on the recipient's computer screen associated with the private e-mail icon.

31. Distributed software as claimed in claim 30 further comprising a means for displaying a private e-mail sender's name and number of the sender's unread messages in an area on the screen associated with the private e-mail icon.

32. Distributed software as claimed in claim 31 wherein the alerting means is a means to alter an appearance of the private e-mail button on a recipient's computer screen.

33. Distributed software as claimed in claim 32 further comprising a means for changing appearance of altered private e-mail icon back to unaltered appearance private e-mail icon when all private e-mail messages have been displayed.

34. Distributed software as claimed in claim 17 further comprising a means for displaying a private e-mail icon on the recipient's computer screen and a means for displays a private e-mail sender's name in an area on the recipient's computer screen associated with the private e-mail icon.

35. Distributed software as claimed in claim 34 further comprising a means for displaying a private e-mail sender's name and number of the sender's unread messages in an area on the screen associated with the private e-mail icon.

36. Private e-mail software stored in machine readable format comprising a private e-mail means for sending and receiving bilaterally authorized private e-mail through a network to private e-mail boxes containing only private e-mail messages from previously authorized senders who were previously authorized to send private e-mail messages to the private e-mail box.
a private e-mail menu means for displaying a private e-mail list of recipients that can be communicated with using the private e-mail means.

37. Private e-mail software as claimed in claim 36 further comprising a private e-mail menu means for displaying a private e-mail list of recipients.

38. Private e-mail software as claimed in claim 36 further comprising a means of alerting the recipient that private e-mail has been received.

39. Private e-mail software as claimed in claim 38 wherein the alerting means is a means to alter an appearance of a private e-mail button on a recipient's computer screen.

40. Private e-mail software as claimed in claim 39 wherein the means to alter an appearance of the private e-mail button includes flashing the private e-mail button.

41. Private e-mail software as claimed in claim 40 further comprising a private e-mail listing means for displaying a list of private e-mail messages in the private e-mail box.

42. Private e-mail software as claimed in claim 41 wherein the private e-mail listing means includes a means for displaying the list of private e-mail messages in the private e-mail box by clicking on the private e-mail button.

43. Private e-mail software as claimed in claim 38 wherein the alerting means is a tray icon on a recipient's computer screen.

44. Private e-mail software as claimed in claim 43 wherein the alerting means is a tray icon on a recipient's computer screen.

45. Private e-mail software as claimed in claim 44 wherein the means to alter an appearance of the tray icon includes flashing the tray icon.

46. Private e-mail software as claimed in claim 44 wherein the means to alter an appearance of the tray icon includes changing a color of the tray icon.

47. Private e-mail software as claimed in claim 44 wherein the alerting means is invoked upon receipt of new information by the application and the tray icon appears on a recipient's computer screen when the alerting means is invoked.

48. Private e-mail software as claimed in claim 47 wherein the tray icon is removed from the recipient's computer screen when the new information is viewed.

49. Private e-mail software as claimed in claim 48 wherein the means to alter an appearance of the tray icon includes flashing the tray icon.

50. Private e-mail software as claimed in claim 49 wherein the means to alter an appearance of the tray icon includes changing a color of the tray icon.

51. Private e-mail software as claimed in claim 50 further comprising a means for displaying a private e-mail icon on the recipient's computer screen and a means for displays a private e-mail sender's name in an area on the recipient's computer screen associated with the private e-mail icon.

52. Private e-mail software as claimed in claim 51 further comprising a means for displaying a private e-mail sender's name and number of the sender's unread messages in an area on the screen associated with the private e-mail icon.

53. Private e-mail software as claimed in claim 52 wherein the alerting means is a means to alter an appearance of the private e-mail icon on the screen.

54. Private e-mail software as claimed in claim 53 further comprising a means for changing appearance altered private e-mail icon back to unaltered appearance private e-mail icon when all private e-mail messages have been displayed.

55. Private e-mail software as claimed in claim 38 further comprising a means for displaying a private e-mail icon on the recipient's computer screen and a means for displays a private e-mail sender's name in an area on the recipient's computer screen associated with the private e-mail icon.

56. Private e-mail software as claimed in claim 38 further comprising a means for displaying a private e-mail sender's name and number of the sender's unread messages in an area on the screen associated with the private e-mail icon.

57. Private e-mail software as claimed in claim 56 wherein the alerting means is a means to alter an appearance of the private e-mail icon on the recipient's computer screen.

58. Private e-mail software as claimed in claim 57 wherein the means to alter an appearance of the private e-mail icon is flashing the private e-mail icon.

59. Private e-mail software as claimed in claim 57 wherein the means to alter an appearance of the private e-mail icon is changing color of the private e-mail icon.

60. Private e-mail software as claimed in claim 57 further comprising a private e-mail listing means for displaying a list of private e-mail messages in the private e-mail box.

61. Private e-mail software as claimed in claim 60 wherein the private e-mail listing means includes a means for displaying the list of private e-mail messages in the private e-mail box by clicking on the private e-mail icon.

62. A multi-tiered network publishing method comprising:
creating multi-tiered publishers distributed software which displays a menu of tiered navigation options associated with tiered publishers,
setting rules for the tiered navigation options below a first tier, and
distributing the multi-tiered publishers distributed software to an end user for installation on an end user computer.

63. The method as claimed in claim 62 further comprising allowing the rules of lower tiered navigation options to be set by an upper tiered one of the publishers.

64. The method as claimed in claim 63 wherein at least a portion of the navigation options are URLs on a network to which the end user computer is connectable.

65. The method as claimed in claim 64 wherein the navigation options further include one or more URLs to files stored on a fixed storage means for fixedly storing files on an end user's computer.

66. The method as claimed in claim 64 further comprising allowing at least one of the tiered publishers to change one or more of the navigation options stored on the end user computer.

67. The method as claimed in claim 64 wherein the navigation options further include one or more applications.

68. The method as claimed in claim 67 wherein at least one of the applications is stored on a fixed storage means for fixedly storing files on the end user computer.

69. The method as claimed in claim 68 wherein at least one of the applications is identified as specific to one of the publishers.

70. The method as claimed in claim 69 further comprising allowing a relatively higher tiered publisher to change one or more of relatively lower tiered ones of the publishers stored on the end user computer.

71. The method as claimed in claim 70 further comprising:
automatically detecting a network connection,
executing a transaction with a network server to determine if any of the publishers and any of the navigation options should be updated, and
updating one or more of the publishers and one or more of the navigation options if so determined from the transaction.

72. The method as claimed in claim 68 further comprising allowing at least one of the publishers to change an associated one of the applications including having the end user computer automatically detecting a network connection and executing a transaction with a network server to determine if any of the applications should be updated and updating one or more of applications stored on the fixed storage means.

73. The method as claimed in claim 72 further comprising the publisher making the change to the associated one of the applications by entering the change though web publishing softwware on the network server.

74. The method as claimed in claim 68 further comprising changing the application icon's appearance to one associated with a particular brandholder whose identification is entered into the application.

75. The method as claimed in claim 62 further comprising sending and receiving bilaterally authorized private e-mail through a network to private e-mail boxes containing only private e-mail messages from previously authorized senders who were previously authorized to send private e-mail messages to the private e-mail box.

76. The method as claimed in claim 75 further comprising displaying a private e-mail list of authorized recipients on a computer screen of the end user computer.

77. The method as claimed in claim 76 further comprising alerting the recipient that the private e-mail has been received.

78. The method as claimed in claim 77 wherein the alerting includes altering an appearance of a private e-mail button on the computer screen.

79. The method as claimed in claim 77 wherein the altering of the appearance of the private e-mail button includes flashing the private e-mail button.

80. The method as claimed in claim 76 further comprising displaying a private e-mail icon and a private e-mail sender's name and number of the sender's unread messages in an area on the screen associated with the private e-mail icon.

81. The method as claimed in claim 80 wherein the alerting includes altering an appearance of the private e-mail icon on a recipient's computer screen.

82. The method as claimed in claim 81 further comprising changing the appearance of altered private e-mail icon back to unaltered appearance private e-mail icon when all private e-mail messages have been displayed.

83. A metod for sending private e-mail method through a network, said method comprising sending and receiving bilaterally authorized private e-mail through a web server on network to private e-mail boxes on at least one end user computer containing only private e-mail messages from previously authorized senders who were previously authorized to send private e-mail messages to the private e-mail box.

84. The method as claimed in claim 83 further comprising displaying a private e-mail list of authorized recipients on a computer screen of the end user computer.

85. The method as claimed in claim 83 further comprising alerting the recipient that the private e-mail has been received.

86. The method as claimed in claim 85 wherein the alerting includes altering an appearance of a private e-mail button on the computer screen.

87. The method as claimed in claim 85 wherein the altering of the appearance of the private e-mail button includes flashing the private e-mail button.

88. The method as claimed in claim 80 wherein the alerting includes altering an appearance of a tray icon on the computer screen.

89. The method as claimed in claim 88 wherein the altering of the appearance of the tray icon includes flashing the tray icon.

90. The method as claimed in claim 88 wherein the altering of the appearance of the tray icon includes changing a color of the tray icon.

91. The method as claimed in claim 88 wherein the alerting means is invoked upon receipt of new information by the application and the tray icon appears on a recipient's computer screen when the alerting means is invoked.

92. The method as claimed in claim 91 wherein the tray icon is removed from the recipient's computer screen wheny the new information is viewed.

93. The method as claimed in claim 27 wherein the means to alter an appearance of the tray icon includes flashing the tray icon.

94. The method as claimed in claim 83 further comprising displaying a private e-mail icon and a private e-mail sender's name and number of the sender's unread messages in an area on the screen associated with the private e-mail icon.

95. The method as claimed in claim 94 wherein the alerting includes altering an appearance of the private e-mail icon on a recipient's computer screen.

96. The method as claimed in claim 95 further comprising changing the appearance of altered private e-mail icon back to unaltered appearance private e-mail icon when all private e-mail messages have been displayed.
